(19) United States
(12) Patent Application Publication
(10) Pub. No.: US 2022/0153455 A1
(43) Pub. Date: May 19, 2022

(54) BI-DIRECTIONAL WAVE PLASMA THRUSTER FOR SPACECRAFT

(71) Applicant: ADVANCED PROPULSION SYSTEMS LLC, gorod Moskva (RU)

(72) Inventor: Andrei Ivanovich SHUMEIKO, Moscow (RU)

(21) Appl. No.: 17/343,993

(22) Filed: Jun. 10, 2021

(30) Foreign Application Priority Data
Nov. 16, 2020 (RU) 2020137435

(51) Int. Cl. B64G 1/40; B64G 1/66; B64G 1/54; B64G 1/24; F03H 1/00

(52) U.S. Cl. CPC B64G 1/405; B64G 1/66; F03H 1/0081; B64G 1/24; B64G 1/54

(57) ABSTRACT

The invention relates to space engineering, in particular, to electric propulsion systems (EP) with electric rocket engines with electrodeless plasma source and acceleration stage using a wide variety of substances as a propellant, designed mainly for installation onboard a spacecraft for transferring it from parking orbit to the target orbit, orbit maintenance, attitude control, altitude control, unloading attitude control systems, maneuvers between orbits, and de-orbiting. The bi-directional wave plasma thruster for spacecraft consists of a gas discharge chamber defining thrust axis, antenna, RF-generator module electrically coupled with antenna, magnetic systems, wherein the gas discharge chamber is configured open to outer atmosphere from two opposite end-faces to form two thrust vectors opposite in direction and having common axis being the axis of the gas discharge chamber, while the antenna is on the outer side of the gas discharge chamber and is surrounded by a ring of dielectric material from its outer side, and there is one magnetic system on each opposite end of the gas discharge chamber, while the gas discharge chamber has a gas dynamic connection line with a propellant supply and storage system by means of two radial gas feedthroughs tightly connected to the gas discharge chamber in two places upstream of the magnetic systems. The technical result is the reduction of thruster weight and dimensions, increase of the specific thrust and specific impulse per consumed power unit, elimination of parasitic discharges damaging thruster and spacecraft structure components, elimination of power losses on the antenna-plasma electromagnetic coupling line, elimination of electromagnetic radiation to the propulsion system components and spacecraft structure components resulting in spacecraft rotation in space.

This application claims priority to RU Patent Application No. 2020137435 filed Nov. 16, 2020, the entire contents of which are hereby incorporated by reference.

### FIELD OF THE INVENTION

The invention relates to space engineering, in particular, to electric propulsion systems (EP) with electric rocket engines with electrodeless plasma source and acceleration stage using a wide variety of substances as a propellant, designed mainly for installation onboard a spacecraft for transferring it from parking orbit to the target orbit, orbit maintenance, attitude control, altitude control, unloading attitude control systems, maneuvers between orbits, and de-orbiting.

### BACKGROUND

The prior art discloses the More efficient RF plasma electric thruster (patent US6293090B1, published on 25 Sep. 2001.) The invention relates to plasma thrusters. It primarily consists of an RF generator, a set of radiating elements, a gas discharge chamber defining the main axis of the thruster, a magnetic system, a power source of the magnetic system, and a propellant supply system connected to a gas discharge chamber.

Its disadvantage lies in that the gas feedthrough is connected to the gas discharge chamber from one of its ends. In this case, the ability to use two ends of the gas-discharge chamber for the flow of plasma and the creation of thrust in this direction is lost. Thus, the volume, mass, and power consumption of the propulsion system increases when several such engines are placed to control several thrust axes, which makes it inefficient or impossible to use them onboard the spacecraft. The use of multiple radiating elements that are fed from a single RF generator for generating a plasma discharge in one gas discharge chamber will lead to instabilities in the generated plasma, which are associated with a difference in electromagnetic radiation generated by the different radiating elements along the length of the gas discharge chamber, which in turn will reduce the thrust and specific impulse of the thruster. The use of multiple closely-spaced radiating elements operating at RF frequencies will lead to the appearance of spurious capacitive coupling discharges between the radiating elements, and between the radiating elements and the magnetic system of the thruster due to the occurrence of capacitive coupling between these elements, which will eventually reduce the efficiency of the thruster, and more specifically , reduce the specific thrust and specific impulse per unit of input RF power, not to mention, it will decrease the thruster service life due to the destruction of elements of the thruster by capacitive coupling discharge sputtering. Moreover, the sputtering of the elements near the gas discharge tube affected by the capacitive coupling discharge sputtering will lead to the impossibility of the power transfer to the plasma. The resulting thruster failure due to the deposition of the sputtered material on the external surface of the gas discharge chamber, will shield the electromagnetic radiation from the plasma generated by the radiating elements. The placement of the gas feedthrough at the upstream side of the gas discharge chamber will result lead to the loss of power to the process of re-ionization of recombined particles of the ionized propellant along the length of the discharge chamber. This in turn leads to a reduction of specific thrust and a specific impulse of the thruster per unit of power.

The prior art discloses Helicon plasma electric propulsion device (patent CN104405603B, published 12 May 2017.). The invention relates to plasma thrusters. It includes at least one metal ring that makes up the thruster housing: the first and second metal flanges, a helicon antenna, a gas discharge chamber, gas feedthrough, and at least two rings of magnets.

The disadvantage of this invention is that the gas feedthrough is connected to the gas discharge chamber from one of its ends. In other words, the ability to use two ends of the gas-discharge chamber for the flow of plasma and the creation of thrust in this direction is lost. Thus, the volume, mass, and power consumption of the propulsion system increases when several such engines are placed to control many thrust axes, which makes it inefficient or impossible to use onboard the spacecraft. The placement of the gas feedthrough at the upstream side of the gas discharge chamber will lead to the loss of power to the process of re-ionization of recombined particles of the ionized propellant along the length of the discharge chamber, which in turn leads to a reduction of specific thrust and a specific impulse of the thruster per unit of power. The use of the Helicon antenna without protective dielectric rings will result in spurious capacitively coupled discharges on the surface of the antenna itself and on the surfaces of other elements proposed in the invention which will eventually reduce the efficiency of the thruster. In particular, it will reduce the specific thrust and specific impulse per unit of input RF power and will decrease thruster service life due to the destruction of elements of the thruster by capacitively coupled discharge sputtering. Moreover, the sputtering of the elements near the gas discharge tube affected by the capacitive coupling discharge sputtering will lead to the impossibility of the power transfer to the plasma and the resulting thruster failure due to the deposition of the sputtered material on the external surface of the gas discharge chamber that will shield the electromagnetic radiation from the plasma generated by the radiating elements.

The prior art discloses the Low-thrust rocket engine for space vehicle (patent RU2445510C2, published on 20 Mar. 2012.) The invention relates to low-thrust rocket engines, and according to claim 24 of the claims, it includes a gas discharge chamber (main chamber) that determines the axis of the thrust forces, a propellant injector, an antenna, magnetic field generators, an electromagnetic field generator, and a generator for changing the direction of the magnetic field.

The disadvantage is that there is only one direction of the thrust of the gas discharge channel. The injector of the propellant closes one of the ends of the gas discharge chamber, which in turn leads to the inefficiency of its use since when using the proposed method of gas ionization—the electromagnetic method—plasma can flow out of the two ends of the gas-discharge chamber. When developing the thruster for a spacecraft (SC), in particular, the thruster with more than one thrust vector, proposed in FIG. 40 and described in p. 60 of claims, the use of only one end of the discharge chamber will increase the weight and dimensions of the engine, which can lead to the inability to use proposed thruster onboard spacecraft due to the high weight and size characteristics. The proposed antenna, in particular the use of capacitively coupled electrodes as the antenna, is impractical for use onboard the spacecraft. This is because a parasitic capacitive discharge will begin to occur on all elements of the propulsion system and spacecraft, which are close to the capacitively coupled electrodes, while the capacitive discharge will destroy both the electrodes themselves and the structural elements of the thruster and spacecraft. The problem of the occurrence and consequences of parasitic capacitive discharge is described in Takahashi, K. (2012.) Radiofrequency antenna for suppression of parasitic discharges in a Helicon plasma thruster experiment, Review of Scientific Instruments, 83(8), 083508 (doi.org/10.1063/1.4748271). Also, the use of a capacitive discharge for ionization of the propellant is an inefficient method of generating plasma for space engines, since the plasma of a capacitive discharge has a low density—no more than 10¹⁶ m⁻³—at low pressure and power, which will not be enough for the efficient operation of the thruster. Data on the plasma density of a capacitive discharge are presented in Chabert and Braithwaite (2011). Physics of radio-frequency plasmas. Cambridge University Press. The proposed antenna, which specifically use of an inductively coupled coil in it, is impractical for use onboard the spacecraft. This is because in this case, the energy from the inductor to the plasma will be transmitted as in a transformer, while the transformation coefficient will not be more than 0.5. Taking into account the power losses on the RF-generator-inductor line and the losses in the antenna, the generation of dense plasma (above 10¹⁸ m⁻³) will require high power (above 800 W), making it impossible to use the thruster with such a plasma source on small spacecraft which have low power capabilities. The proposed antenna, in particular the use of Double-Saddle and Loop antennas, is also impractical for use onboard small spacecraft. This is because, as in the case with the use of capacitively coupled electrodes, at low power, parasitic capacitive discharges will occur on the surface of the antenna itself and structural elements of the thruster and spacecraft. Due to the sputtering of the metal antenna and the metal elements of the thruster, the external surface of the gas discharge tube will be covered with a metal film, which will shield electromagnetic waves generated by an antenna, and the ionization process of the propellant inside the discharge chamber will be impossible, i.e. this case will lead to the thruster failure. The proposed location of the gas feedthrough at the upstream side of the gas discharge chamber is inefficient in terms of power transfer in the plasma. In this case, the ionization of the propellant takes place at the beginning of the gas discharge chamber and the antenna capable for the wave propagation regime in plasma is used (Double-Saddle and Loop antenna), the more power to ionization will be required since the formation of waves in plasma occurs downstream side from the antenna. The use of a large number of magnetic systems is impractical because for the plasma acceleration, a single magnetic nozzle at the outlet of the gas-discharge chamber is sufficient. A large number of magnetic systems leads to the increase of the mass and volume of the thruster. The invention does not have an electromagnetic shielding system. A device that uses electromagnetic waves and a magnetic field to generate and accelerate plasma creates electromagnetic radiation, which, when absorbed by the elements of the spacecraft and can cause a magnetic moment to start rotating the spacecraft, as well as cause failures in the operation of the payload of the spacecraft or destruct it.

### DISCLOSURE OF THE INVENTION

The technical problem to be solved by the claimed invention is creation of bi-directional wave plasma thruster for spacecraft with reduced weight and dimensions for transferring spacecraft between orbits, orbit maintenance, attitude control, altitude control, unloading attitude control systems, maneuvers between orbits, and de-orbiting, which increases thruster specific thrust and specific impulse per consumed power unit, and which is free from parasitic discharges damaging thruster and spacecraft structure components, which is free from power losses on the antenna-plasma electromagnetic coupling line, free from electromagnetic radiation to the propulsion system components and spacecraft structure components resulting in spacecraft rotation in space.

The technical result is the reduction of thruster weight and dimensions, increase of the specific thrust and specific impulse per consumed power unit, elimination of parasitic discharges damaging thruster and spacecraft structure components, elimination of power losses on the antenna-plasma electromagnetic coupling line, elimination of electromagnetic radiation to the propulsion system components and spacecraft structure components resulting in spacecraft rotation in space.

To solve the aforementioned problems with achievement of the claimed technical result the bi-directional wave plasma thruster for spacecraft comprises a gas discharge chamber defining thrust axis, antenna, RF generator module electrically coupled with antenna, magnetic systems, wherein the gas discharge chamber is configured open to outer atmosphere from two opposite end-faces to form two thrust vectors opposite in direction and having common axis being the axis of the gas discharge chamber, while the antenna is on the outer surface of the gas discharge chamber and is surrounded by a ring of dielectric material from its outer side, and there is one magnetic system on each opposite end of the gas discharge chamber, while the gas discharge chamber has a gas dynamic connection line with a propellant supply and storage system by means of two radial gas feedthroughs tightly connected to the gas discharge chamber in two places upstream of the magnetic systems.

Each of the magnetic systems consists of two electromagnets connected to the power sources of magnetic systems.

The first electromagnet is configured to generate a magnetic field that is transversal to the axis of the corresponding gas discharge chamber, and the second electromagnet is configured to generate axial magnetic field that is parallel to the axis of the corresponding gas discharge chamber, wherein the first electromagnet is farther from the corresponding end-face of the gas discharge chamber than the second electromagnet.

The thruster additionally comprises rigid structure components consisting of rods composing a frame, which the structure components of bi-directional wave plasma thruster for spacecraft are fixed to.

The thruster additionally comprises a control module configured to form controlling actions on the systems and modules of the bi-directional wave plasma thruster for spacecraft, to collect information on the thruster systems and modules characteristics, and also to transmit the collected information to the spacecraft for following transmission to the ground station.

### BRIEF DESCRIPTION OF THE DRAWINGS

FIG. 1—block diagram of the proposed bi-directional wave plasma thruster for spacecraft;

FIG. 2—spacecraft bi-directional wave plasma thruster, isometric view.

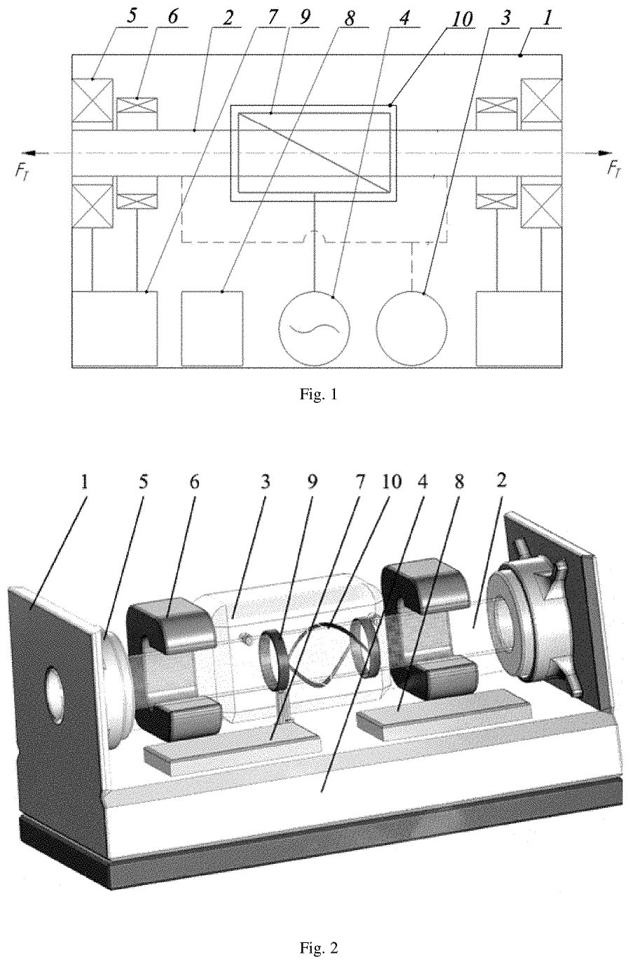

### DETAILED DESCRIPTION OF THE DRAWINGS

The bi-directional wave plasma thruster for spacecraft is proposed to be used onboard satellites, including small satellites, for transferring it from parking orbit to the target orbit, orbit maintenance, attitude control, altitude control, unloading attitude control systems, maneuvers between orbits, and de-orbiting.

The claimed thruster is bi-directional and consists of the following components with their functions:

gas discharge chamber (2) rigidly connected to the thruster rigid structure components (1). The gas discharge chamber (2) is made of dielectric material in the form of a cylinder with walls, which thickness could be different, however, such as on the cylinder axis there is a through cylindrical path inside the gas discharge chamber (2). On the outer side of the gas discharge chamber (2) there is the antenna (9) generating electromagnetic field inside the gas discharge chamber (2) for propellant ionization. Each opposite end-face of the gas discharge chamber is open to outer space. There is one magnetic system on each opposite end-face of the gas discharge chamber (2). Each magnetic system comprises two electromagnets—electromagnet (5) generating axial magnetic field parallel to axis of the gas discharge chamber (2) and electromagnet (6) generating a magnetic field transversal to the axis of the gas discharge chamber (2). The gas discharge chamber (2) is a channel (path), where plasma is generated. The axis of the gas discharge chamber (2) aligns with axises of controlling actions on the spacecraft, i.e. the axis of the gas discharge chamber (2) aligns with thrust vectors, FT, generated by accelerated plasma flows exhausting from the end-faces of the gas discharge chamber (2). The accelerated plasma flow can exhaust from the gas discharge chamber (2) in two opposite directions, i.e. the gas discharge chamber (2) has two thrust vectors having common axis being the axis of the gas discharge chamber (2), but opposite in direction. Due to the fact that the gas discharge chamber (2) is open to outer space from two opposite end-faces, enabling to form two thrust vectors opposite in direction, the spacecraft weight and dimensions could be reduced, since instead of two individual thrusters, each of which has one thrust vector, one claimed bi-directional wave plasma thruster for spacecraft is sufficient to generate two thrust vectors.

The gas discharge chamber (2) upstream of the electromagnets (5) and (6) of the magnetic system has tight connection to the radial gas feedthroughs of the propellant supply and storage system (3);

antenna (9) electrically coupled with R-generator module (4). The antenna (9) eliminates power losses on the antenna-plasma electromagnetic coupling line, and it is located on the outer surface of the gas discharge chamber (2). RF power is supplied to the antenna (9) from the RF-generator module (4) through RF-generator-antenna electric line, and this RF power is converted by the antenna (9) to the alternating magnetic field inside the gas discharge chamber (2). Alternating magnetic fields generated by the antenna (9) inside the gas discharge chamber (2) generate eddy electric currents that cause free electron oscillations existing in every medium. Electron oscillations inside the gas discharge chamber (2) cause avalanche ionization of the propellant fed into the gas discharge chambers (2) through the radial gas feedthroughs of the propellant supply and storage system (3), i.e. plasma generation process takes place inside the gas discharge chamber (2). Upon availability of axial magnetic field generated by the electromagnets (5) of the magnetic system, the electromagnetic fields generated by the antenna (9) cause formation of self-induced electromagnetic waves in plasma, in particular, helicon waves, which in turn generate Traivelpice-Gould waves or oblique Langmuir waves, which increase degree of plasma ionization inside the gas discharge chamber (2) and effectively transfer power from the antenna (9) to plasma inside the gas discharge chamber (2). Dielectric ring (10) is fixed on the outer surface of the antenna (9), and this ring excludes electromagnetic radiation to the thruster components, i.e. the antenna (9) is covered by the dielectric ring (10). Increase of thruster specific thrust and specific impulse per consumed power unit is ensured by the fact that the antenna (9) generates plasma and then enables self-induced electromagnetic waves generation in it, which effectively transfer the power from antenna (9) into plasma.

dielectric ring (10) fixed on the outer surface of the antenna (9), which covers the antenna outside from the other space of the bi-directional wave plasma thruster for spacecraft. The ring (10) could be made of any dielectric material, for example, Al₂O₃, quartz glass. The dielectric ring (10) prevents the inner space of the bi-directional wave plasma thruster for spacecraft from electromagnetic radiation generated by the antenna (9). The dielectric ring (10) prevents from generation of parasitic capacitive discharges between the antenna (9) outer surface and thruster structure components;

magnetic systems, each of which is located one of two end-faces of the gas discharge chamber (2) and consists of electromagnets (5) and (6) electrically coupled with the power sources of magnetic system (7), while the electromagnets (5) generate axial magnetic field that is parallel to axis of the gas discharge chamber (2) and the electromagnets (6) generate a magnetic field that is transversal to the axis of the gas discharge chamber (2). The electromagnets (5) are located closer to open end-faces of the gas discharge chamber (2), the electromagnets (6) are located next to the electromagnets (5) from the side farther from the corresponding end-face of the gas discharge chamber (2). The electromagnets (5), located immediately next to the end-face of the gas discharge chamber (2) and generating axial magnetic field parallel to the axis of the gas discharge chamber (2), accelerate plasma generated in the gas discharge chamber (2) by means of four plasma acceleration mechanisms—electrostatic, electromagnetic, gas-dynamic, Joule heating. The electromagnets (6) generating a magnetic field transversal to the axis of the gas discharge chamber (2) serve as plasma lenses, i.e. control plasma flow when passing through the magnetic field transversal to the axis of the gas discharge chamber (2) due to generation of a space charge which can prevent plasma to flow in the set direction. Thus, the electromagnets (6) serve as plasma lenses to decrease amount of plasma outflowing in one of two possible directions of the gas discharge chamber (2) or prevent from plasma flowing in one of the directions, i.e. it is possible to control thrust vectors created from each end-face of the gas discharge chamber (2) by means of the electromagnets (6). Also, the control mechanisms of plasma flow can be performed by changing the direction of axial magnetic field lines generated electromagnets (5) because plasmas follow magnetic field lines direction;

RF-generator module (4) which supplies and controls power input to plasma in the gas discharge chamber (2) by means of the antenna (9) electrically coupled with RF-generator module (4). Control of the power input to plasma in the gas discharge chamber (2) by means of the antenna (9) is required to control thrust vectors FT because the change of the input power to the plasma results in change of plasma density;

propellant supply and storage system (3) comprising at least one propellant storage tank, two radial gas feedthroughs tightly connected to the propellant feed system (3) components and tightly connected to the gas discharge chamber (2) upstream of the electromagnets (5) and (6) of the magnetic systems. The propellant supply and storage system (3) is rigidly fixed on the thruster rigid structure components (1). The propellant supply and storage system (3) is designed to store propellant in the tank, prepare and control propellant flow rate in the propellant feed components, inject propellant to the gas discharge chamber (2) by means of radial gas feedthroughs;

The thruster could also additionally comprise:

control module (8) which sets controlling actions on propellant feed and storage system (3), RF-generator module (4), power sources of magnetic systems (7), collects information on the systems and modules characteristics of the bi-directional wave plasma thruster for spacecraft, transmits the collected information to the spacecraft for following transmission to the ground station, receives information about controlling actions sent to the spacecraft from the ground station;

the thruster rigid structure components (1) composing a frame and electromagnetic shielding system consisting of the shielding elements fixed on the frame. The thruster rigid structure components (1) consist of the rods composing the frame to which the systems and modules of the bi-directional wave plasma thruster for spacecraft are fixed, the side surfaces of this frame are covered by the electromagnetic shielding system elements, which exclude electromagnetic radiation to the spacecraft, wherein there is one hole for the gas discharge chamber end-faces on one of two opposite thruster frame side surfaces, and one of the side surfaces is fixed to the spacecraft. The thruster rigid structure components (1) support the components of the bi-directional wave plasma thruster for spacecraft, such as gas discharge chamber (2), propellant supply and storage system (3), RF-generator module (4), magnetic systems (electromagnets (5), (6)), power sources of magnetic systems (7), control module (8). The thruster rigid structure components (1) are rigidly connected to the spacecraft. The thruster rigid structure components (1) take the thrust forces transferred to the thruster rigid structure components (1) from the electromagnets (5), to which the thrust forces are transferred from plasma exhausting from the gas discharge chamber (2) along the lines of axial magnetic field generated by the electromagnets (5). The thruster rigid structure components (1) transfer thrust forces taken by them to the spacecraft through rigid connection between the thruster rigid structure components (1) and the spacecraft, thereby moving the spacecraft in the space. The electromagnetic shielding system being part of the thruster rigid structure components (1) and the electromagnetic shielding system consists of thin elements absorbing electromagnetic radiation, and these elements can be made of copper, aluminum, iron (except for steels), titanium, and other non-magnetized metals. Thin elements of the electromagnetic shielding system cover the outer surface of the bi-directional wave plasma thruster for spacecraft. The electromagnetic shielding elements is to eliminate effect of electromagnetic radiation and magnetic fields of the bi-directional wave plasma thruster for spacecraft on the spacecraft structure elements, systems and modules.

One of the main tasks solved by the bi-directional wave plasma thruster for spacecraft is creation of two thrust vectors making controlling actions on a spacecraft for transferring it from parking orbit to the target orbit, orbit maintenance, attitude control, altitude control, unloading attitude control systems, maneuvers between orbits, and de-orbiting.

The advanced developments in the field of EP address using of a magnetic nozzle to control plasma flow, i.e. using magnetic nozzles for plasma acceleration. EP using magnetic nozzles are classified as electromagnetic and include magnetoplasmadynamic, helicon, electron cyclotron resonance (ECR), ion cyclotron resonance (ICR), microwave (MW) thrusters, and Direct Fusion Drive. These cutting-edge thrusters are necessary to comply with the requirements of future space missions and are developed to generate specific impulse and specific thrust higher than the existing EP have with the same power level.

Magnetic nozzles, represented in the invention as electromagnets (5), like Laval nozzles, convert thermal energy of propellant particles into directed kinetic energy. The advantage of magnetic nozzles is that contact of high-temperature plasma with the magnetic nozzle surface is minimized, while the magnetic nozzles enable to use additional mechanisms of thrust formation due to interaction of electromagnetic fields of plasma and magnetic field of the magnetic nozzle.

The mechanisms by which thermal energy is extracted from the plasma using electromagnets (5) of magnetic systems include the law of conservation of the adiabatic invariant of the magnetic moment, the electric field forces, the direction of thermal energy, and Joule heating. The mechanisms of plasma separation include resistive diffusion of the magnetic field, recombination processes in the plasma, magnetic reconnection of magnetic field lines, loss of adiabaticity of the plasma expansion process, the effects of inertial forces, and the effects of stratification of the lines of self-induced electromagnetic fields. The process of pulse transmission from the plasma to the spacecraft is a consequence of the interaction between the lines of the applied magnetic field created by the electromagnet of the magnetic system (50) and the induced flows that are formed due to the magnetic pressure.

Three key steps are required to generate thrust in the magnetic nozzles:
Convert thermal energy of plasma into directed kinetic energy;
Effective separation of the plasma from the magnetic field lines;
Transmission of the angular momentum from the plasma to the spacecraft.

The main mechanisms used for energy conversion in the magnetic nozzle and the corresponding types of acceleration between which the energy is transferred are presented below:
Conversion of the adiabatic invariant magnetic moment and plasma detachment (acceleration in an electromagnetic field);
Acceleration in an electric field (electrostatic acceleration);
Direction of thermally heated particle motion (gas-dynamic acceleration);
Joule heating (thermal acceleration).

### Conservation of Magnetic Moment Adiabatic Invariant.

Particle magnetic moment is adiabatically constant during motion, if the magnetic field variation at one period of cyclotron motion is many times less than the magnitude of the magnetic field. Adiabaticity conditions could be presented by different dependencies. The most commonly used condition is defined by the ratio of the Larmor radius r_{L}=mv_{⊥}/(qB) to the characteristic length of the magnetic field variation defined as 1/|gradB|:

r_{L}|gradB|<<1.

For further description of adiabatic energy exchange let us use the simplified energy expression for isentropic, collisionless and equipotential plasma as follows:

$${K}_{\sum } = {K}_{⊥} + {K}_{II} = \frac{{mv}_{⊥}^{2}}{2} + \frac{{v}_{II}^{2}}{2} = const .$$

One can see from these equations that reduction of the magnetic field force results in increase of particle velocity parallel to the magnetic field. This behavior is similar to familiar magnetic mirror physics. Combination of these equations results in the following ratio for a velocity parallel to the magnetic field:

v_{II}=\sqrt{v_{Σ}²−2μₘB/m.}

It could be additionally understood, if we assume that the flow, where perpendicular velocity component is initially dominant, flows gradually to an area with very small magnetic field. Expression of discharge velocity for this flow is demonstrated below and is the expression for complete conversion of the energy related to the magnetic moment parallel to the kinetic energy.

v_{II,max}=\sqrt{2μₘB₀/m.}

### Electrostatic Acceleration

Electrostatic acceleration could be caused by formation of ambipolar fields or double layers. These mechanisms are the result of high mobility of electrons as compared to ions. This high mobility is characterized by thermal velocity. Mobile electrons in the diverging magnetic nozzles form electron pressure gradient ahead of slow ions. Electrical field which accelerates ions and slows down electrons is formed to maintain quasi-neutrality. This results in energy exchange between electron thermal velocity and ion flow velocity.

Though ambipolar acceleration and acceleration in a double layer are caused by similar physics, they are absolutely different. Double layers are characterized by electric potential change in the area of several Debye lengths, while electric potential at ambipolar mechanism could be of the order of characteristic length of the system.

### Direction of Thermally Heated Particle Motion

Kinetic energy could be generated by guiding thermal energy. Laval nozzles guide thermal motion into axial direction through convergent-divergent physical wall. Magnetic nozzles make it by constraining plasma in the required geometric form by means of strong guiding magnetic field. Physics of energy conversion is based on hydrodynamics, and magnetic nozzle geometry is defined by interaction between plasma and magnetic field. It is understood that ratios based on hydrodynamics, similar to those used in Laval nozzles analysis, could be used for analysis of this energy conversion, with neglect of losses occurred at magnetic wall formation.

Main condition of plasma constraining in respect to thermal forces is characterized by the ratio of continuum pressure to magnetic pressure represented in the following expression:

$${β}_{p} = \frac{n {k}_{B} T}{{B}^{2} \text{/} 2 {μ}_{0}} .$$

If this ratio is complied with, i.e. magnetic pressure is stronger than thermal pressure, plasma constraining is possible, however, not guaranteed. Plasma constraining could also require formation of current sheet at the boundary between plasma and vacuum. Diffusion and convection processes could deteriorate the current sheet; therefore, they should be understood so that losses caused by nonideality of plasma constraining.

### Joule Heating

Energy exchange could also occur at interaction of electromagnetic and hydrodynamic fields. Such exchange is better described by the equation of magnetohydrodynamics energy given below:

$$\frac{δ {e}_{H}}{δ t} + ∇ \cdot [ U ( {e}_{H} + p ) - k ∇ T + U \cdot τ ] = J \cdot E .$$

The right part of the above expression is the expression for heating according to Joule-Lenz law and describes the energy generated by a continuum as a result of energy loss by the electromagnetic field. The same part of the expression but with the reversed sign is represented in the equation of the electromagnetic field energy.

$$\frac{1}{2} \frac{δ}{δ t} ( {ɛ}_{0} {E}^{2} + \frac{1}{{μ}_{0}} {B}^{2} ) + ∇ \cdot [ \frac{1}{{μ}_{0}} E \times B ] = - J \cdot E .$$

According to Shumeiko and Telekh (2019, November). Probe diagnostics of the plasma plume created by a magnetic nozzle of an inductively coupled plasma source. Journal of Physics: Conference Series (Vol. 1393, No. 1, p. 012027), IOP Publishing (doi:10.1088/1742-6596/1393/1/012027) the results of measuring the velocity of the plasma flow at the exhaust of the magnetic nozzle (in the invention electromagnets (5) of the magnetic system), accelerated by the electrostatic mechanism, i.e. the formation of a double-layer in the plasma flow at the exhaust of the magnetic nozzle, are presented. It is shown that the plasma flow can be accelerated up to 11 km*s⁻¹ at relatively low powers (120 W) and low external magnetic field (200 G). The specific impulse created by the magnetic nozzle in the experiment is sufficient for effective operations in inner space.

The above design of the claimed bi-directional wave plasma thruster for spacecraft ensures reduction of the thruster weight and dimensions, elimination of power losses on the antenna-plasma electromagnetic coupling line, elimination of electromagnetic radiation to the propulsion system components and spacecraft structure components resulting in spacecraft rotation in space, ensures increasing thruster specific thrust and specific impulse per consumed power unit.

1. The bi-directional wave plasma thruster for spacecraft comprising a gas discharge chamber defining thrust axis, antenna, RF-generator module electrically coupled with antenna, magnetic systems, wherein the gas discharge chamber is configured open to outer space from two opposite end-faces to form two thrust vectors opposite in direction and having common axis being the axis of the gas discharge chamber, while the antenna is on the outer side of the gas discharge chamber and is surrounded by a ring of dielectric material from its outer side, while there is one magnetic system on each opposite end of the gas discharge chamber, while the gas discharge chamber has a gas dynamic connection line with a propellant supply and storage system by means of two radial gas feedthroughs tightly connected to the gas discharge chamber in two places upstream of the magnetic systems.

2. The thruster according to claim 1 wherein each of the magnetic systems consists of two electromagnets connected to the system powering magnetic systems.

3. The thruster according to claim 1 wherein first electromagnet is configured to generate a magnetic field transversal to the axis of the corresponding gas discharge chamber, and the second electromagnet is configured to generate axial magnetic field parallel to the axis of the corresponding gas discharge chamber, wherein the first electromagnet is farther from the corresponding end-face of the gas discharge chamber than the second electromagnet.

4. The thruster according to claim 1 wherein it additionally comprises rigid structure components consisting of rods composing a frame, which the structure components and plasma thruster modules are fixed to.

5. The thruster according to claim 1 wherein it additionally comprises the electromagnetic shielding system consisting of the components covering the outer surface of the rigid structure components and absorbing electromagnetic radiation.

6. The thruster according to claim 1 wherein it additionally comprises the control module configured to form controlling actions on the thruster systems and modules, to collect information on the thruster system and module characteristics, and also to transmit the collected information to the spacecraft board for subsequent transmission to the command post.
